(19) United States
(12) Patent Application Publication
(10) Pub. No.: US 2003/0151342 A1
(43) Pub. Date: Aug. 14, 2003

(54) Ignition device, in particular, spark plug

(76) Inventors: Carsten Venn, Bamberg (DE); Klaus Hrastnik, Stuttgart (DE); Thomas Jaeger, Erdmannshausen (DE); Hellmut Schmid, Sachsenheim (DE)

Correspondence Address: KENYON & KENYON, ONE BROADWAY, NEW YORK, NY, 10004, US

(21) Appl. No.: 10/312,545

(22) PCT Filed: May 3, 2001
(86) PCT No.: PCT/DE01/01677

(30) Foreign Application Priority Data
Jul. 1, 2000 (DE) 10032186.0

(51) Int. Cl. H01T 13/20

(52) U.S. Cl. 313/143

(57) ABSTRACT

In an ignition device, especially a spark plug (10), having a housing (12) that is provided with a screw-in thread (14), a permanent sticking or contact corrosion of the spark plug in the cylinder head is to be prevented. For this purpose, it is provided that the housing, at least in the region of the screw-in thread, include a coating (26) of a varnish provided with nonstick pigments.

### BACKGROUND INFORMATION

The present invention is directed to an ignition device, especially a spark plug, which is provided with a housing that includes a screw-in thread.

Such a spark plug is screwed by its screw-in thread into a receiving bore in a cylinder head of an internal combustion engine, so that electrodes formed at the spark plug project into the cylinder chamber. In response to an appropriate electric potential being applied to the electrodes, an ignition spark may be generated in the cylinder chamber, with whose aid an ignitable mixture in the cylinder chamber may be ignited.

Because of the ambient conditions prevailing in the region of the screw-in thread during operation of the spark plug, it can happen that it becomes difficult to unscrew the spark plug from the cylinder head, for instance, when replacing the spark plug. In particular following a service life of the spark plug corresponding to a kilometer reading of more than 60,000 km of the motor vehicle using the same engine, it can happen that the housing of the spark plug permanently sticks to the cylinder head or that contact corrosion occurs there. Permanently sticking means that the thread play between the spark plug and the cylinder head is obstructed by oil or other products from the cylinder chamber. These products may lead to layers adhering to the screw-in thread, making it difficult or even impossible to unscrew the spark plug. On the other hand, contact corrosion is to be understood as a reaction between the surface of the screw-in thread and the cylinder head, which may occur without additional corrosion media or without the aid of such corrosion media. Especially when the housing of the spark plug is provided with zinc in the region of the screw-in thread, as a protective layer against corrosion, problems occur during unscrewing because of contact corrosion of the screw-in thread. The reason for this is that, according to the phase diagram, zinc, which is often used as a material for cylinder heads, reacts with aluminum even at low temperatures. However, when using nickel for the protective layer against corrosion, no reactions are to be expected at the prevailing operating temperatures of approximately 220° according to the phase diagram. Nevertheless, such may not be ruled out since reactions are possible as a result of locally occurring contact bridges. Finally, contact corrosion is aided by the vibratory movements that occur during engine operation, which allow a pointwise frictional welding.

The object of the present invention is the reliable prevention of permanent sticking of the housing in the cylinder head or of contact corrosion in this region in an ignition device of the type mentioned in the introduction, even during an extended service life.

### SUMMARY OF THE INVENTION

In the ignition device having the features of Claim 1, the nonstick pigments of the coating reliably prevent combustion residue and engine oils originating from the cylinder chamber from depositing in the helical threads of the screw-in thread, thereby preventing permanent sticking. Furthermore, due to their separating effect, the antistick pigments prevent a reaction from taking place between the surface of the screw-in thread and the cylinder head. In this manner, contact corrosion of the spark plug is prevented. Should permanent sticking or contact corrosion occur locally, nevertheless, the nonstick pigments, due to their lubricating effect, reduce the torque during unscrewing, so that the spark plug may be unscrewed from the cylinder head in a reliable manner. The coating with the gliding, separating and nonstick varnish according to the present invention has another advantage in that the screw-in thread, due to the wear resistance of the varnish, need not be protected by additional measures during manufacture and shipping of the spark plugs, for instance, by plastic sleeves which, during shipping, must be placed on the screw-in thread of some spark plugs known from the related art.

Particularly suitable as nonstick pigments are PTFE pigments, graphite pigments, molybdenum-sulphide pigments and boron-nitride pigments. Metal oxides may be used as well. All of these materials provide the desired gliding, separating and nonstick effects.

According to a preferred specific embodiment of the present invention, the varnish in addition may be provided with metal pigments. This results in better thermal conductivity from the spark plug to the cylinder head, which improves the functioning of the spark plug.

Moreover, it may be provided that the varnish has a composition by which an additional protective effect against corrosion is achieved. In this manner, a layer protecting against corrosion is formed, which may also be applied to external areas of the screw-in thread, thereby reliably preventing a corrosion of the metal housing of the spark plug in the hot and corrosive atmosphere that exists during engine operation.

According to a preferred specific embodiment of the present invention, it is provided that the varnish includes a binding agent which allows a rapid curing with the aid of UV-radiation, IR-radiation or by induction drying. The short drying times of the varnish thus made possible allow the varnishing process to be integrated into the production line of the spark plug. The varnish application is preferably carried out subsequent to the assembly of the spark plug. Given the short drying time of the varnish, the spark plug may then be quickly packaged and shipped.

### BRIEF DESCRIPTION OF THE DRAWING

The present invention is described below with the aid of a preferred specific embodiment, which is represented in the enclosed drawings, which show:

FIG. 1 a part-sectional representation of a spark plug according to the present invention; and

FIG. 2 cut-away portion II of FIG. 1, shown in an enlarged scale.

### DESCRIPTION OF THE EXEMPLARY EMBODIMENTS

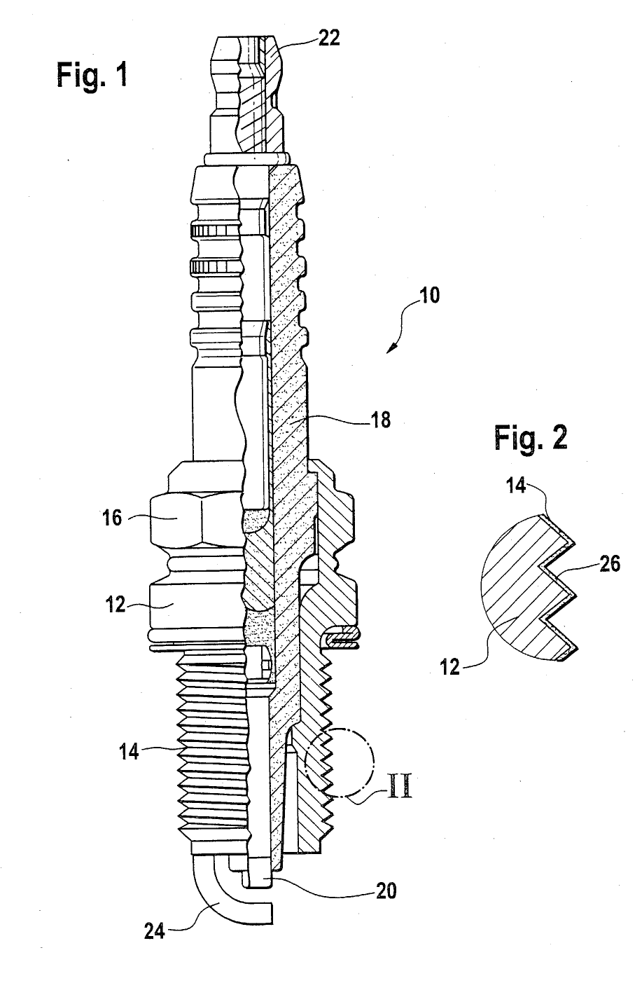

FIG. 1 shows a part-sectional view of an ignition device according to the present invention, which in this case is designed as spark plug 10. Spark plug 10 has a housing 12 which includes a screw-in thread 14 and a hex nut 16. Screw-in thread 14 is used to screw the spark plug into a bore having a complementary thread, the bore being located in a cylinder head of an internal combustion engine.

In the interior of housing 10, an insulator 18 and a center electrode 20 are disposed in a known manner, the center electrode being in electrically conductive connection to a connecting nut 22 located on the insulator. Across from center electrode 20 is at least one ground electrode 24, which is mounted on housing 12. By applying an appropriate electric potential between connecting nut 22 and housing 12, an ignition spark may be generated between the two electrodes, which is used to ignite an ignitable mixture in the cylinder of the engine.

As can be seen more clearly from FIG. 2, screw-in thread 14 of housing 12 is provided with a coating 26, which consists of a varnish that includes nonstick pigments. The nonstick pigments may be PTFE pigments, graphite pigments, molybdenum-sulphide pigments and boron-nitride pigments. The pigments impart a gliding, separating and nonstick effect to the coating, by which a permanent sticking of screw-in thread 14 to the bore in the cylinder head or the forming of contact corrosion there are prevented.

To obtain the desired gliding, separating and nonstick effect to prevent permanent sticking or contact corrosion, it suffices if coating 26 is provided in the region of the screw-in thread. However, if it is desired that the coating also achieve a corrosion protection, the entire housing 12 is preferably coated with varnish.

What is claimed is:

1. An ignition device, especially a spark plug (10), having a housing (12) which is provided with a screw-in thread (14),
wherein the housing, at least in the region of the screw-in thread, includes a coating (26) of a varnish provided with nonstick pigments.

2. The ignition device as recited in claim 1,
wherein the nonstick pigments are PTFE pigments.

3. The ignition device as recited in claim 1,
wherein the nonstick pigments are graphite pigments.

4. The ignition device as recited in claim 1,
wherein the nonstick pigments are molybdenum-sulphide pigments.

5. The ignition device as recited in claim 1,
wherein the nonstick pigments are boron-nitride pigments.

6. The ignition device as recited in claim 1,
wherein the nonstick pigments are metal-oxide pigments.

7. The ignition device as recited in one of the preceding claims,
wherein the varnish coating (26) is additionally provided with metal pigments.

8. The ignition device as recited in one of the preceding claims,
wherein the varnish coating (26) has a composition by which in addition a corrosion protection is achieved.

9. The ignition device as recited in one of the preceding claims,
wherein the varnish includes a binding agent which allows a rapid hardening with the aid of UV-radiation, IR-radiation or by induction drying.
